(19) United States
(12) Patent Application Publication
(10) Pub. No.: US 2006/0291492 A1
(43) Pub. Date: Dec. 28, 2006

(54) Method and Apparatus for Publishing a Community Based Directory and of Offering Associated Community Based Services

(76) Inventor: Daniel Michael Paul Nugara, Wayne, IL (US)

Correspondence Address: VEDDER PRICE KAUFMAN & KAMMHOLZ, 222 N. LASALLE STREET, CHICAGO, IL, 60601, US

(21) Appl. No.: 11/464,646

(22) Filed: Aug. 15, 2006

Related U.S. Application Data
(63) Continuation-in-part of application No. 11/056,302, filed on Feb. 11, 2005.

(51) Int. Cl. H04L 12/56

(52) U.S. Cl. 370/401

(57) ABSTRACT

This invention relates to a method or apparatus for publishing a community-based directory and profile using a tangible or a digital equivalent and an intangible publication. The intangible publication consists of using at least two different digital communication protocols or using a fixed and a mobile device. Selected members listed in the community-based directory are also able to access a list of digital services such as file storage, file transfer, electronic communications, management of information, marketing tools, etc. from the digital communication locations.

### RELATED APPLICATION

This application is a continuation-in-part of U.S. patent application Ser. No. 11/056,302, filed Feb. 11, 2005, which is hereby fully incorporated by reference.

### FIELD OF THE INVENTION

The present invention relates generally to an information system, and more particularly to a method and apparatus for publishing a community-based directory and profile, a community-based directory, and of offering associated community-based services.

### BACKGROUND OF THE INVENTION

Digital era tools revolutionize the way information is gathered, compiled, treated, published, and distributed to people, groups of people, businesses, and community-based organizations such as chambers of commerce. Digital publications are slowly being substituted for paper-based publications such as almanacs, agendas, directories, dictionaries, encyclopedias, etc. These tangible publications were traditionally used to compile, publish, and distribute information.

In the second half of the 20th century, some believed intangible publications would eventually replace tangible publications such as newspapers. However, this belief assumes as a postulate that digital indexing supersedes human visual recognition and indexing of tangible publications, or that new methods for distributing tangible publications will not be implemented. Intangible publications have yet to offer readers the ease and portability of information gathering associated with tangible publications or digital equivalents. Telephone directories, magazines on a doctor's waiting room table, and airplane seat pocket magazines are examples of publications that have not been replaced by digital versions. Today large files in PDF format are sent via the internet to recipients able to print at their destination tangible publications. Both tangible and intangible mediums possess advantages and disadvantages over the other. Depending on the type of community at issue, as well as their needs, tangible publications can still become an essential part of a publishing method that spans across a multitude of technology.

New protocols for the distribution of intangible information include, but are not limited to, the HyperText Transfer Protocol (HTTP), the Wireless Application Protocol (WAP), the Lightweight Directory Access Protocol (LDPA), the Transport Control Protocol/Internet Protocol (TCP/IP). Distribution of data using these protocols may be conducted through a number of different types of networks, such as, for example, an intranet, a local area network (LAN), a wireless LAN, or a wide area network (WAN). The remote devices can also directly transfer data between themselves across wireless link using an appropriate technology, such as Bluetooth™ wireless technology, to create so-called personal area networks (PAN) or personal ad-hoc networks. More specifically, the HTTP allows for internet data transfer, and WAP allows for wireless transfer to telephones and other portable devices. Intangible digital publications can be equipped with digital indexing means that allow a better access to the digital information. Digital publication means can be of greater utility to some communities faced with large volumes of information. The legal community is a common example where digital indexing allows for more rapid retrieval of relevant information. Other communities with a smaller volume of information to transit, like community-business directories such as chambers of commerce, do not benefit from a complete transition from a tangible publication or digital equivalent to an intangible digital publication.

These new protocols allow devices of increasing capacities to connect to the internet and offer portable versions of on-line community-based directories. Portable devices, such as Portable Digital Assistants (PDAs), Electronic Books (e-books) or wireless telephones are often equipped with smaller displays and relay smaller amounts of information associated with an indexing means for limited display capacities. Some community-based directories and community-based directory and profiles, such as community business organizations are particularly adapted to portable device size displays since the user generally will need information on a limited number of business entities.

Currently, communities such as community business organizations insist on developing the publication and services associated with these protocols of information in association with a tangible publication or its digital equivalent. They must maintain a central core paper-based publication or provide clients with a digital version of a document that must be printed off-site and rely on a second service provider to insure a limited on-line presence that is conceptually unrelated to their main tangible publication. This invention does not relate to on-line services researching into extensions of a first intangible publication toward other intangible publications such as wireless phone displays, PDA displays, and e-book displays. It has been the practice in this field to try and move community-based directories and profiles and community-based directories away from the tangible editions by arguing for improved indexing and availability.

No provider offers a method and a related apparatus that addresses the tangible publication or a digital equivalent as an essential part of the community-based directory publication method, and also offers an intangible publication developed without being limited to a single communication protocol. Members of a community business organization are currently unable to rely on a single method and system for publishing a community-based directory and profile, or a community-based directory in both a tangible and digital equivalent and intangible medium and use this directory as a base for associated on-line services limited to their members.

### SUMMARY OF THE INVENTION

This invention relates to a method or apparatus for publishing a community-based directory or a community-based directory and profile using both a tangible or a digital equivalent and at least one intangible publication. The tangible publication in the best mode contemplated by the inventors is a paper-based catalog, but the creation of a master digital document to be printed at remote locations or displayed in the form of a printed publication is contemplated. The intangible publication is made by using at least two different digital communication protocols. Selected members listed in the community-based directory and the community-based directory and profile are also able to access a list of digital services and marketing tools such as file storage, file transfer, electronic communications, management of information, sales and purchasing aides, sales advertising aides, public relation services, etc. from locations where the intangible publications are published. Information systems for communities comprise, but are not limited to, directory services, where members or advertisers of the community are listed, and profile information composed of a large variety of factual information such as, editorial, historical, advertisement, social events, location and transportation, tourism attractions and lodging, history, celebrations, homes and residential living, parks and recreation, dining, shopping, education, businesses, economic development, healthcare, government services, worship, etc.

Information is first selected and collected using manual or digital means and a database is created using the information obtained from items of interest within a chosen community. The database is then transformed into a community-based directory if no profile information is collected and a community-based directory and profile if profile information is collected. A tangible paper-based publication or a digital equivalent is published and distributed. The community-based directory or the community-based directory and profile is also published in an intangible format using two different communication protocols. Fixed or mobile devices may be equipped to receive and display the intangible publication or publications. In the best mode contemplated by the inventor, at least the name, category, and contact information of members of a community business organization such as a chamber of commerce are selected, collected, and stored; profile information is also collected and stored. In the best mode, the items of interest chosen are business entities and the information is at a minimum the name, the type of business, and the address of the member of the community business organization. A minimum of two different publications are published of the community-based directory and profile or the community-based directory and at least one intangible version of the community-based directory and profile or the community-based directory; first a paper-based high-quality color publication is made and distributed or a digital file in the form of an electronic document that may be displayed, second a HTTP protocol on-line directory is made available on-line on a fixed device, and this version is also published using a wireless telephone and the associated WAP protocol for portable devices.

Tangible and intangible publishing tools are used to facilitate the collection and display of information in each of the publications, including the transfer of digital files. Users are also able, using intangible publication display devices to select and display only a part of the publication by selecting items of interest to be displayed. Members of the community will also, through their presence within the community-based directory or the community-based directory and profile have access to community-based directory services.

### BRIEF DESCRIPTION OF THE FIGURES

A better understanding of the present invention may be derived from the detailed description and the claims when considered in conjunction with these figures. The reference numbers refer to similar elements throughout the figures.

FIG. 1 illustrates a flow diagram showing a series of method steps performed to implement the method for publishing a community-based directory and profile.

FIG. 2 further illustrates the item of interest illustrated in FIG. 1.

FIG. 3 schematically illustrates an apparatus and method to implement the apparatus for publishing a community-based directory and profile or a community-based directory in accordance with an exemplary embodiment of the present invention.

FIG. 4 schematically illustrates the best mode of the apparatus and method as contemplated by the inventor to implement the apparatus and method for publishing a community-based directory and profile or a community-based directory.

FIG. 5 illustrates a flow diagram showing a series of method steps performed to implement the user selection steps for the method for publishing a community-based directory and profile, or a community-based directory, displaying additional information and services to members of the community-based directory and profile, or community-based directory.

FIG. 6 illustrates a flow diagram showing a series of method steps performed to implement the method for publishing a community-based directory;

### DETAILED DESCRIPTION OF THE INVENTION

Where reference numerals represent the same elements in all of the views, FIG. 1 illustrates a flow diagram showing a series of method steps performed to implement the method for publishing a community-based directory and profile. Community-based directories and profiles are derivative from a community 8 encompassing a plurality of items of interest 7 and profile information 10. The community 8 is illustrated as a circle, the items of interest 7 are illustrated as squares for illustrative purposes only, and the profile information 10 is illustrated as a smaller circle for illustrative purposes only. A community is defined as an assembly or a group consisting of a plurality of items of interest. Examples of possible communities 8 include, but are not limited to, members of community business organizations, members of chambers of commerce, owners of classical cars, users of a certain medication, patent holders, etc. In a preferred embodiment, the selected community is a community business organization more precisely a chamber of commerce.

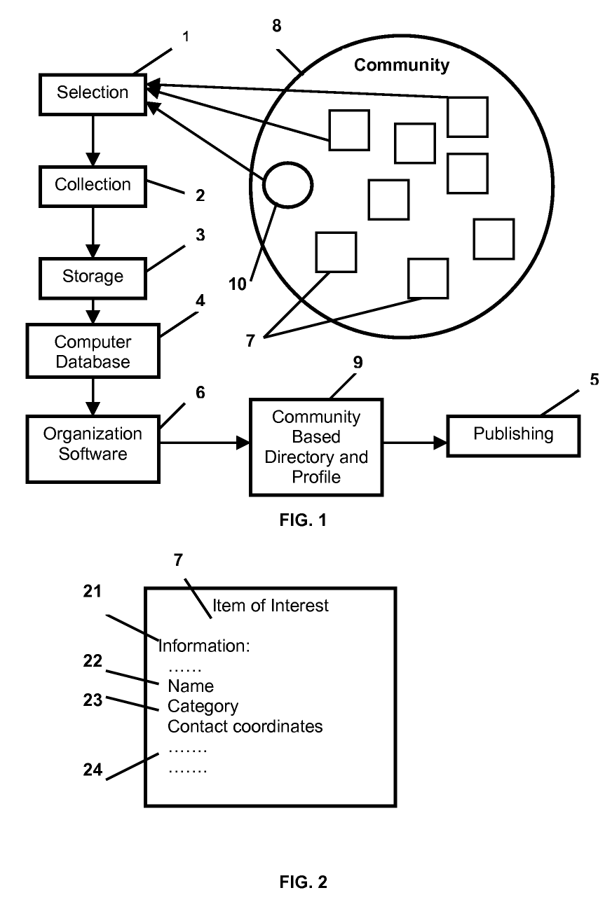

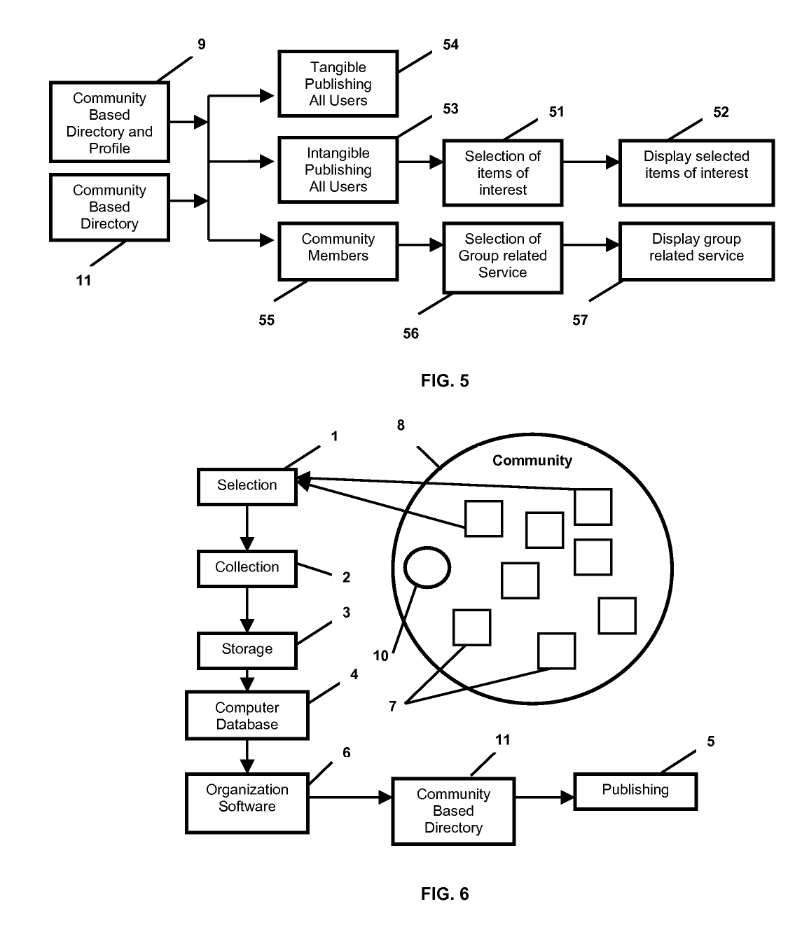

Within each of these communities, there is a multitude of items of interests 7, and profile information 10. FIG. 6 illustrates the same situation as FIG. 1 where no profile information is selected and a simple community-based directory is created. FIG. 2, provides a detailed illustration of a sample item of interest 7 and how the information 21 is associated with each item of interest. The minimum information 21 associated with each item of interest 7 comprises a name 22, a category 23 also called a type or attribute, and contact coordinates 24. In the preferred embodiment, the item of interest 7 is at a minimum a business entity member of a community business directory where each member is described by the name of the business entity, the business type, and the address of the business. The listed information 21 associated with each item of interest 7 corresponds to the minimal information needed to form a community-based directory and profile. The profile information may be limited to as little as the name of the community but may also include a wide range of information such as editorial, historical, advertisement, social events, location & transportation, tourism attractions and lodging, history, celebrations, homes and residential living, parks and recreation, dining, shopping, education, businesses, economic development, healthcare, government services, worship, etc.; a wide variety and format of additional information may be collected and stored for each item of interest 7. In FIG. 5, where community members 55 gain access to a selected group of services 56, other types of information 21 related to the item of interest 7 can be stored alongside the name 22, a category 23 and the contact coordinates 24 as part of the information 21 for a selected item of interest 7.

Returning to the detailed description of FIG. 1, the first step of the method corresponds to the selection 1 of some to all of the items of interest 7 in the selected community 8 and of the profile information 10. In the preferred embodiment, the selection is the determination that the business is an active member of a community business organization such as a chamber of commerce. FIG. 6 illustrates the case where the first step corresponds to the selection 1 of only some to all of the items of interest 7 in the selected community 8, and no profile information is selected. The second step in FIG. 1 corresponds to the collection 2 of the information selected. Collection of the information may be conducted over the phone, obtained from an existing or obsolete directory, entered by potential members using an on-line interface, researched, or by any collection means. The collected information 2 is then stored 3 in the third step in a computer database 4. Storage is made by entering the collected 2 information 21 from the items of interest 7 into a computer database 4 using a conventional computer and associated software. The collection and storage of the information 21 may include any other information from the items of interest 7 in addition to the name 22, the category 23 and the contact coordinates 24.

Using an organization software 6, the computer database is then modified into a community-based directory and profile 9 containing some or all of the information stored in the computer database 4. The community-based directory and profile 9 is then used as the information to be published 5. FIG. 6 illustrates the case where only the information from items of interest 7 is used to create a community-based directory 11.

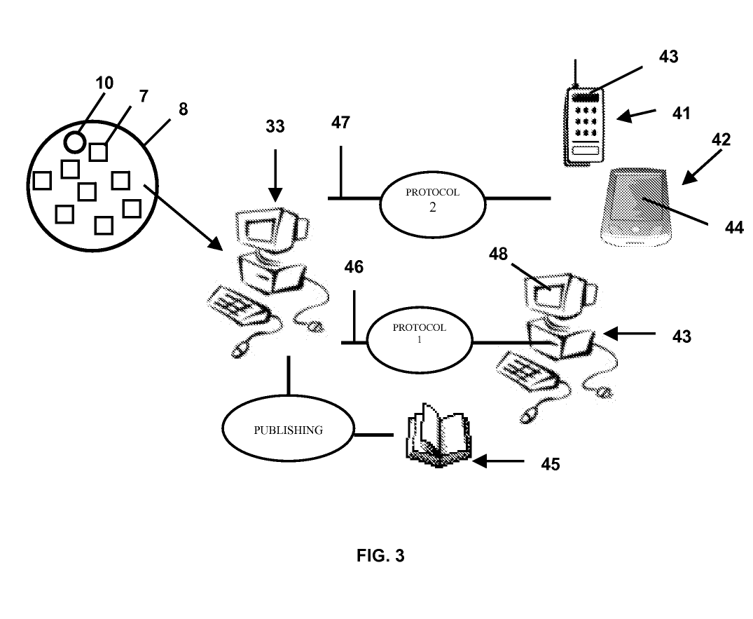

FIG. 3 schematically illustrates the apparatus and method associated with this invention. The community 8 items of Interest 7 and in some case the profile information 10 are selected, collected and stored using a computer database 4 and an organization software 6 in order to produce a community-based directory and profile 9 as shown in FIG. 1 or a community-based directory 11 as shown in FIG. 6. The community-based directories 9, or 11 are then illustrated to be located in the processor and the associated memory of a computer 33. The computer 33 can be of any type capable of data entry, storage and transformation, like a mainframe server, part of a network, a personal computer, an artificial intelligence, or any piece of hardware containing a memory and an associated processor. While the computer 33 in FIG. 3 is illustrated as a single piece of hardware, the storage, collection, storage can be conducted on different physical locations serving the same overall purpose.

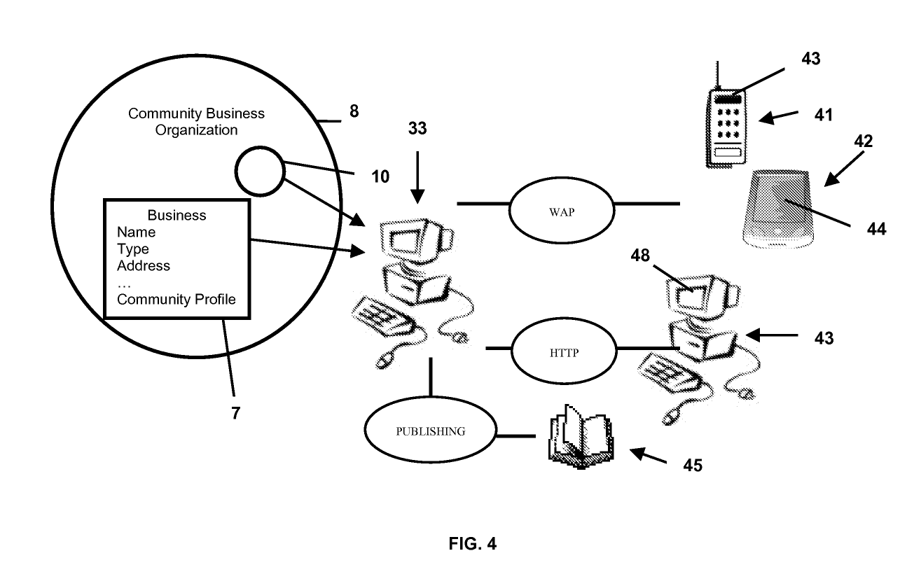

The community-based directory and profile 9 or the community-based directory 11 are then published using a tangible medium 45 or a digital equivalent, and at least two different data transfer protocols 46, and 47. In the preferred embodiment illustrated as FIG. 4, the first protocol 46 is the HyperText Transfer Protocol (HTTP), and the second protocol 47 is of Wireless Access Protocol (WAP) 47, the first intangible publication is done on a fixed device and the second intangible publication is done on a portable device. The first protocol 46 is connected to a personal computer 43 either fixed or mobile, capable of connecting to the HTTP portion of the internet. The community-based directory and profile 9 or the community-based directory 11 is then displayed on the second computer 43 using the display 48. In the best mode contemplated, the community-based directory and profile 9 or the community-based directory 11 is permanently located at a HTTP address that may be accessed by the preferred embodiment, the second device is either a wireless phone 41, a wireless personal assistant 44 or an e-book 44; all three devices have been used alternatively and none was found to be functionally superior. The community-based directory and profile 9 and the community-based directory 11 are displayed on a display 43, or 42. Other communication protocols may be used such as the Lightweight Directory Access Protocol (LDPA), the Transport Control Protocol/Internet Protocol (TCP/IP), etc. Of course, distributed data may also include a number of different types selected users. The computer 33 publishes using a second protocol 47 to a mobile of fixed device capable of displaying the community-based directory and profile 9, as illustrated on FIG. 1, or the community-based directory 11, as illustrated on FIG. 6. In of networks, such as, for example, an intranet, a local area network (LAN), a wireless LAN, or a wide area network (WAN). The remote devices can also directly transfer data between themselves across wireless link using an appropriate technology, such as Bluetooth™ wireless technology, to create so-called personal area networks (PAN) or personal ad-hoc networks.

One of ordinary skill in the art will understand that the availability, scalability, and versatility of industrial and color printers has changed how tangible publications are produced, distributed and used in the marketplace. Large print quantities are progressively replaced by smaller print quantities used in association with a digital format master copy of the tangible publication for printed when desired. What is contemplated herein as a tangible publication and a tangible medium 45 is a publication directed ultimately at being held or watched by an end user in either a physical medium such as paper, or a display of a file that may not be altered by the end user where the user is able to obtain a tangible medium version at will. In lieu of a non-limiting example, a PDF of a publication, or a master version produced of a printable document such as a catalog provided as a file that may alternatively be viewed on a display is a tangible publication.

FIG. 4 illustrates the above mentioned preferred embodiment as contemplated by the inventor. FIG. 5 illustrates a flow diagram showing a series of method steps performed to implement the user selection steps for the method for publishing a community-based directory and profile 9 or a community-based directory 11, displaying additional information and services to members of the community-based directory. In a first step, the tangible or digital equivalent and intangible publication is published to any possible users 53 and 54 that may wish to gain access to the community-based directory and profile 9, or the community-based directory 11. In the preferred embodiment, access to the community-based directories 9, and 11 is not limited to subscribers, it is open to any user or member of the public, but in another possible embodiment, access may be limited to subscribers of the service. Every user is allowed to select certain items of interest 51 for display 52 part of the intangible publication 53. In the preferred embodiment, users are allowed to select a category, a location relating to a smaller group of businesses as part of the members from a community business organization business directory for display. Community members 55 part of the items of interest 7 in the community-based directory and profile 9, or community-based directory 11, are granted access to a selection of group related services 56 that may also be displayed 57 on a fixed or portable devices 41, 42, 43 as described on FIG. 3. Selected members listed in the community-based directory 11 and the community-based directory and profile 9 are also able to access a list of digital services and marketing tools such as file storage, file transfer, electronic communications, management of information, sales and purchasing aides, sales advertising aides, public relation services, etc. from locations where the intangible publications are published.

The description of the present invention has been presented for the purpose of illustration and is not intended to be exhaustive or limited to the disclosure of the embodiments. Many modifications and variations will be apparent to those of ordinary skill in the art. The embodiments were chosen to explain the principles of the invention and its practical applications and to enable others of ordinary skill in the art to understand the invention in order to implement various embodiments, including the disclosed best contemplated mode, with various modifications as might be suited to other contemplated uses or methods.

We claim:

1. A method for providing information services about a community, the method comprising the steps of: selecting items of interest within a community; collecting information regarding said items of interest, the information including, for each item of interest, at least a name, a category, and contact coordinates; storing the information as a computer database; organizing the computer database into a community-based directory; publishing a digital equivalent of a tangible edition of the community-based directory; and publishing at least one intangible edition of the community-based directory using at least two different technology protocols.

2. The method of claims 1, wherein said selection of said items of interest within a community is determined by a membership to a Community Business Organization.

3. The method of claim 1, wherein said selection of said items of interest within a community is determined by a membership to a Chamber of Commerce.

4. The method of claim 2, wherein said information regarding said items of interest is the name of a business entity, the type of business entity, and the address of the business entity.

5. The method of claim 4, wherein said information further includes a community profile.

6. The method of claim 4, wherein one of the technology protocols is the Wireless Application Protocol (WAP).

7. The method of claim 4, wherein one of the technology protocols is the HyperText Transfer Protocol (HTTP).

8. The method of claim 7, wherein a second technology protocol is the Wireless Application Protocol (WAP).

9. A method for providing information services about a community, the method comprising the steps of: selecting items of interest within a community; collecting information regarding said items of interest, the information including, for each item of interest, at least a name, a category, and contact coordinates; selecting a community profile information; storing the information as a computer database; organizing the computer database into a community-based community and profile; publishing a digital equivalent of a tangible edition of the community-based directory and profile; and publishing at least one intangible edition of the community-based directory and profile using at least two different technology protocols.

10. The method of claim 9, wherein said selection of said items of interest within a community is determined by a membership to a Community Business Organization.

11. The method of claim 9, wherein said selection of said items of interest within a community is determined by a membership to a Chamber of Commerce.

12. The method of claim 10, wherein said information regarding said items of interest is the name of a business entity, the type of business entity, and the address of the business entity.

13. The method of claim 12, wherein said information further includes a Community Profile.

14. The method of claim 12, wherein one of the technology protocols is the Wireless Application Protocol (WAP).

15. The method of claim 12, wherein one of the technology protocols is the HyperText Transfer Protocol (HTTP).

16. The method of claim 15, wherein a second technology protocol is the Wireless Application Protocol (WAP).

17. The method of claim 12, wherein one of the intangible editions is an electronic book (e-book).

18. A method for providing information services about a community, the method comprising the steps of: selecting items of interest within a community; collecting information regarding said items of interest, the information including, for each item of interest, at least a name, a category, and contact coordinates; storing the information as a computer database; organizing the computer database into a community-based directory and profile; publishing a digital equivalent of a tangible edition of the community-based directory and profile; displaying on a fixed device a first intangible edition of the community-based directory and profile; and displaying on a mobile device a second intangible edition of the community-based directory and profile.

19. The method of claim 18, wherein said selection of said items of interest within a community is determined by a membership to a Community Business Organization, and said tangible edition is a paper-based business directory and profile catalog.

20. The method of claim 18, wherein said selection of said items of interest within a community is determined by a membership to a Chamber of Commerce, and said tangible edition is a paper-based business directory and profile catalog.

21. The method of claim 19, wherein said mobile device is a wireless telephone.

22. The method of claim 19, wherein said mobile device is a personal data assistant.

23. The method of claim 20, wherein said fixed device is a personal computer.

24. The method of claim 20, wherein at least one intangible edition of the device is an electronic book (e-book).

25. The method of claim 20, wherein the digital equivalent of the tangible edition is a PDF format file.
